(19) United States
(12) Patent Application Publication
(10) Pub. No.: US 2026/0217335 A1
(43) Pub. Date: Jul. 30, 2026

(54) A Stern Roller Arrangement

(71) Applicant: Kongsberg Maritime AS, Kongsberg (NO)

(72) Inventor: Kjetil RISØ WAAG, Ålesund (NO)

(21) Appl. No.: 19/149,122

(22) PCT Filed: Jan. 11, 2024
(86) PCT No.: PCT/NO2024/050006

§ 371 Date: Jul. 18, 2025

(30) Foreign Application Priority Data
Jan. 20, 2023 (NO) 20230048

(51) Int. Cl. B63B 21/10; B66D 1/36

(52) U.S. Cl. CPC B63B 21/10; B66D 1/36

(57) ABSTRACT

A stern roller arrangement for a vessel, said stern roller arrangement comprises at least two stern roller drums rotatably supported on a drum axle and a rope sheave independently and rotatably supported on a sheave axle. The rope sheave is mounted in-between two adjacent stern roller drums, and the rope sheave comprises removable sheave segments, said sheave segments making up a full-circle rope sheave when assembled.

### BACKGROUND

The disclosed embodiments relate to a stern roller arrangement for a vessel with at least two stern roller drum rotatably supported on a drum axle, and a rope sheave independently and rotatably supported on a sheave axle.

Active heave compensation (AHC) is a technique used on lifting equipment to reduce the influence of waves upon marine operations. Active heave compensation differs from passive heave compensation by having a control system that actively tries to compensate for any movement at a specific point. The purpose of active heave compensation is to keep a load motionless regarding the seabed or another vessel.

The performance of an active heave compensation system is normally limited by power, motor speed and torque, by sensor measurement accuracy and delay, or by computing algorithms. Choice of control method, like using preset values or delayed signals, may affect performance and give large residual motions, especially with unusual waves.

State of the art active heave compensation systems are real time systems that can calculate and compensate any displacement in a matter of milliseconds. Accuracy then depends on the forces on the system, and thus the shape of the waves more than the size of the waves.

In a winch system, the wave movement is compensated by automatically driving the winch in the opposite direction at the same speed as the ship motion at the wire exit point. The load of the winch will thus keep its position relative to the seabed. Active heave compensation winches are used e.g., in ROV-systems, in cranes and for lifting equipment that is to operate near or at the seabed. Compensation can include tension control, aiming to keep wire tension at a certain level while operating in waves. Wires, used to guide a load to an underwater position, may use active heave compensation and tension control in combination.

The rope from the winch on anchor handler vessels normally runs past the stern roller of the vessel and down into the water and the load. A stern roller is basically a big drum on a shaft with bearings. It allows ropes, wires, chains, etc., to be hauled up and out into the water with low friction, powered by a winch located elsewhere on board the vessel.

In for instance anchor handling operations, the load on the rope and thus on the stern roller may be severe. The stern roller is also normally quite large and has thus a high moment of inertia. With a large enough load, it is normally not a problem to accelerate the stern roller back and forth, following the movement of the rope, to provide active heave compensation. A problem arises when the load is too small, as the forces from the rope or wire is not enough to overcome the stern roller's moment of inertia to rotate the stern roller and the rope may slip against the surface of the stern roller. The rope and/or the stern roller may in such a case be subjected to damage. Further, the whole active heave compensation operation can as a result be jeopardized.

In for instance anchor handling operations and heave compensated operations, the load on the rope and thus on the stern roller may be severe. The rope normally is chosen to only have a diameter and safe working load corresponding to the tension load. For these loads in a rope the need for protecting the rope itself is present. Having an independent rolling system for these ropes is of great advantage and sustainable for any type of rope or chain running with high tension loads.

For instance, with a particular wave height and length, the stern roller must at any given time have a large enough load in view of the moment of inertia of the stern roller. That may not always be the case, and the above-mentioned problems may arise. The same problem may arise when the load has been placed on the seabed and the vessel is raised or lowered by a wave.

Today's solution does not meet Marine Operation Standards without mobilizing special equipment on deck or using A-frame or crane.

NO 20180894 A1 discloses a vessel comprising a rope sheave arrangement with a first rotatable wire sheave and a second rotatable wire sheave, wherein the first rotatable wire sheave is placed on a stern roller of the vessel and connected by a pair of support arms to a support mounted on a deck of the vessel. The second rotatable wire sheave is placed on the deck of the vessel and in front of the support.

### SUMMARY

It is an object to provide a stern roller arrangement that allows the rope to pass the stern of the vessel, without being influenced by stern roller movement or without inflicting stern roller movement.

By rope is meant a fiber (fibre), chain, wire or any other rope used in marine operations.

It is also an object to provide a stern roller arrangement that improves active heave compensation operation during anchor handling, particularly when an A frame or crane is not installed or in use.

The inventive embodiments provide an integrated rope sheave in the stern roller, with simplified service/dismantle and reduced tool requirements, and thus cost and efficiency. Hence, the embodiments can thus provide a more compact stern roller arrangement combined with a rope sheave.

The rope sheave may be modularized with different type of groove profiles. It may also be possible to use different types of bearing depending on operation and maintenance need.

The rope sheave can be used to protect a rope, such as a steel or fiber rope, when marine operations involve a constant tension or a heave compensated rope operation. The rope sheave can also be used for other operations like, paying out, hauling in wire or chain handling by changing the profile to suite any preferred chain or rope.

The disclosed embodiments are primarily intended for use with Anchor Handling Vessels (AHT), Cable Laying Vessel (CLV), Offshore Supply and Construction (OSCV), and Barges.

A stern roller arrangement for a vessel is provided, said stern roller arrangement comprising at least two stern roller drums rotatably supported on a drum axle and a rope sheave independently and rotatably supported on a sheave axle. The rope sheave is mounted in-between two adjacent stern roller drums, and the rope sheave comprises removable sheave segments, said sheave segments making up a full-circle rope sheave when assembled.

Optionally are several rope sheaves mounted in-between two adjacent stern roller drums.

The drum axle and the sheave axle can share a common center axis. However, the drum axle and the sheave axle may have different center axes.

The drum axle can be supported on the sheave axle. It is also possible that the sheave axle is supported on the drum axle.

The drum axle ends can each comprise bearings, and the sheave axle can comprise a bearing.

The sheave segments can be attachable to the sheave axle.

The stern roller arrangement can further comprise a support structure supporting the stern roller arrangement to the vessel on either side of the rope sheave(s).

The support structure can comprise a lower support structure, such as a support bracket, with a bearing bed for receipt of the drum axle or the sheave axle, securing the drum axle and the sheave axle.

The support structure can also comprise an upper support structure, wherein said upper support structure is arranged to at least partly cover a gap between the rope sheave and the adjacent stern roller drum.

### BRIEF DESCRIPTION OF THE DRAWINGS

Embodiments of the present invention will now be described, by way of example only, with reference to the following figures, wherein:

FIGS. 1 and 2 show perspective views of a stern roller arrangement according to one embodiment of the disclosure.

FIG. 3 shows a front view a stern roller arrangement according to the disclosure.

FIG. 4 shows a cross section along F-F in FIG. 3.

FIG. 5 shows a stern roller arrangement according to the disclosure installed on a vessel.

FIGS. 6-9 show a mounting procedure of a stern roller arrangement according to one embodiment.

### DETAILED DESCRIPTION

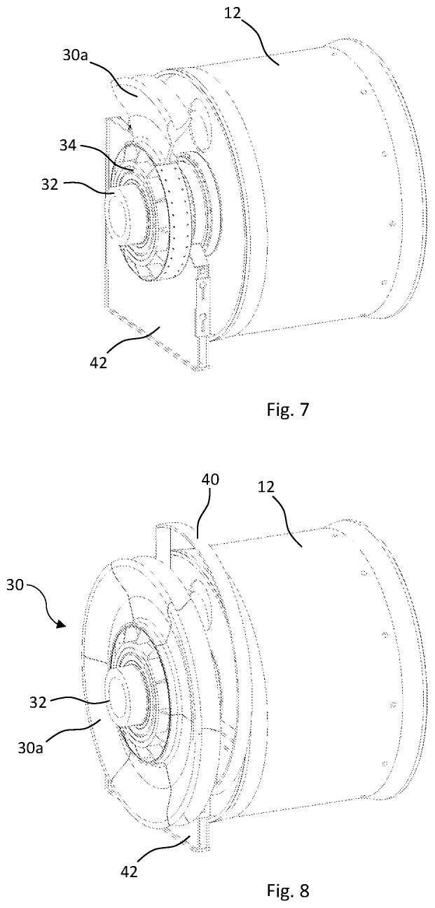

Disclosed herein is a stern roller arrangement 10 intended to be mounted on a vessel 20, as for instance seen in FIG. 5, using a support structure 18. The stern roller arrangement 10 is to be mounted on the aft of the vessel 20.

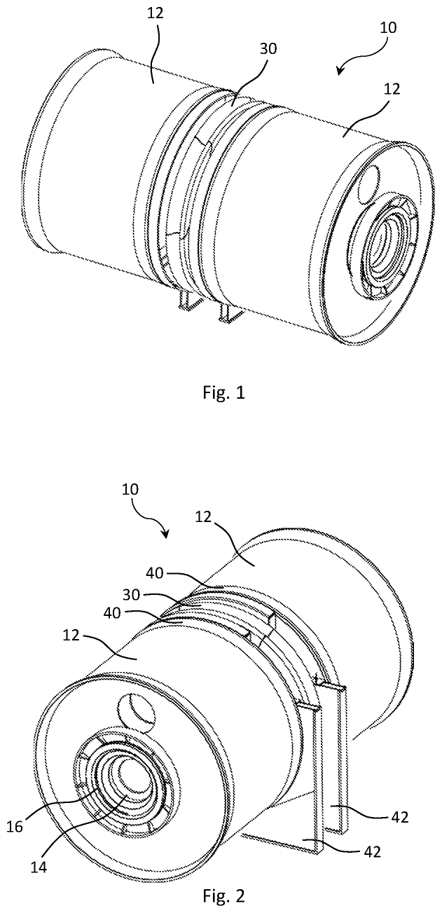

FIGS. 1 and 2 show an embodiment of the stern roller arrangement 10 in perspective views, and which comprises two adjacent stern roller drums 12. The stern roller drums 12 can basically be designed like an ordinary stern roller but are preferably shorter lengthwise to fit on the aft of the vessel 20. Each stern roller drum 12 is rotatably supported on separate drum axles 14 with bearings 16. An independent rope sheave 30 is rotatably supported on a sheave axle 32 with a bearing 34 and is placed in-between the two stern roller drums 12, such that the rope sheave 30 and the stern roller drums 12 can rotate independent of each other.

The Figures show one rope sheave 30 placed in-between two adjacent stern roller drums 12. However, in other embodiments, it is possible to use two or more rope sheaves 30 in-between two stern roller drums 12, and for that matter one or more rope sheaves 30 on the stern roller drum 12 outer side ends. Several pairs of stern roller drums 12 could possibly be used, and with a rope sheave 30 as disclosed placed in-between.

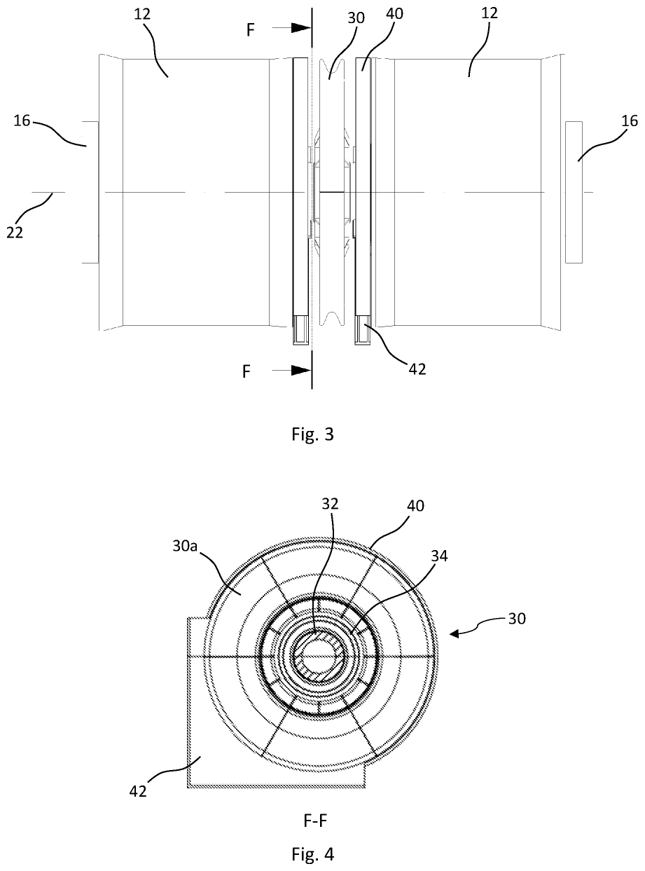

The drum axle 14 of the stern roller drum 12 and the sheave axle 32 of the rope sheave 30 can share a common center axis 22. The common center axis 22 is illustrated in FIG. 3. However, in case it is desirable to use different diameter on the stern roller drums 12 and the rope sheave(s) 30, it might be needed to offset the center axes, such that the drum axle 14 and the sheave axle 32 have different center axes.

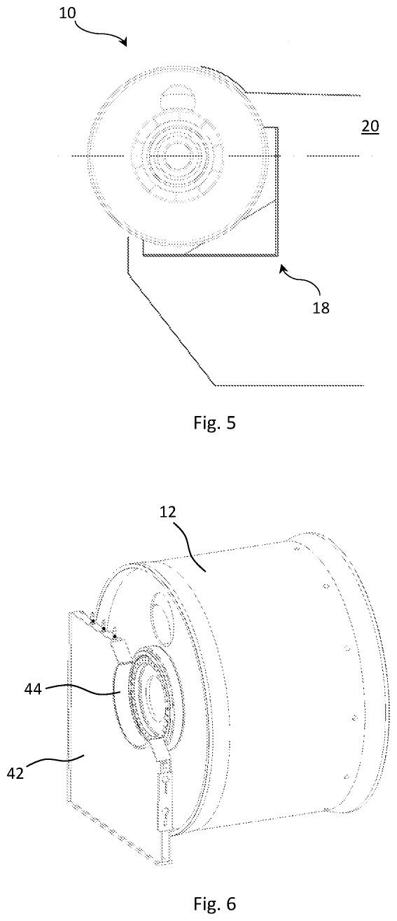

FIG. 3 shows a front view a stern roller arrangement 10, and FIG. 4 shows a cross section along F-F in FIG. 3, and shows that the rope sheave 30 can comprise several removable sheave segments 30a that can make up a full circle rope sheave 30 when assembled. The sheave segments 30a are attachable to the sheave axle 32 with the bearing 34, such that the rope sheave 30 can rotate independent of the stern roller drums 12.

The drum axles 14 and bearings 16 of the stern roller drums 12 are on their outer side ends conventionally supported to the vessel 20. The sheave axle 32 and bearing 34 of the rope sheave 30, and the drum axles 14 and bearings 16 facing the rope sheave 30, are supported on the support structure 18 in manner wherein the stern roller drum 12 is supported on the drum axle 14 ends and on the sheave axle 32, or the opposite, that the sheave axle 32 is supported on the drum axle 14 ends.

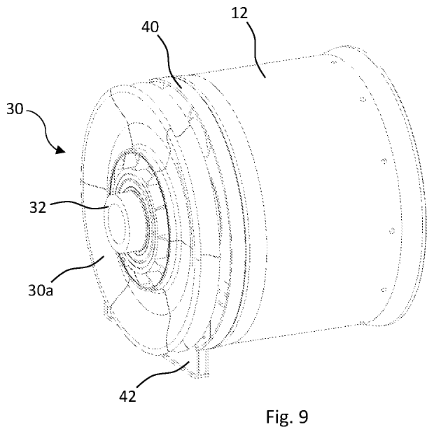

The support structure 18 can support the stern roller arrangement 10 to the vessel 20 on either side of the rope sheave(s) 30. As seen for instance in FIG. 6, the support structure 18 comprises a lower support structure 42, such as a support bracket, mounted to the vessel. The lower support structure 42 further comprises a bearing bed 44, which can function as a still standing bearing securing the drum axle 14 and/or the sheave axle 32.

The support structure 18 further comprises an upper support structure 40, see for instance FIGS. 8 and 9, which is connected to the lower support structure 42. The upper support structure 40 can cover a gap between the rope sheave 30 and the adjacent stern roller drum 12. The lower support structure 42 may comprise holes and bolts for connection of the upper support structure 40.

The rope sheave 30 is removable without removing the stern roller drums 12, for easy maintenance of the bearing 34 and to easy change the sheaves profile. The rope sheave 30 can have any profiled shape to the best suited geometry for the product, the operation it is intended for, do require.

The main purpose of the rope sheave 30 is to protect a steel or fiber rope when marine operations involve a constant tension or a heave compensated rope operation. The rope sheave can also be used for other operations like, paying out, hauling in wire or chain handling by changing the profile to suite any preferred chain.

The system is designed and built so that the upper support structure 40 of the vessel support structure 18 can be removed from deck level and/or an inside vessel compartment. When the upper support structure 40 is removed, the axle bearings are slide sideways out using bolts. These bearings are still standing (not rotating) with the vessel structure. The rope sheave 30 is rotating on the sheave axle 32 and the stern roller drums 12 on their conventional bearing system.

FIGS. 6-9 show a mounting procedure of a stern roller arrangement 10 according to one embodiment.

In FIG. 6 the stern roller drum 12 is installed and resting on the lower support structure 42. Thereafter is the sheave axle 32 with the bearing 34 (here shown with one sheave segment 30a) lifted into a still-standing bearing bed 44 on the lower support structure 42. The bearing 34 of the sheave axle 32 is slid sideways on the sheave axle 32 into the bearing 16 of the drum axle 14 and secures the drum axle 14 of the stern roller drum 12 and the sheave axle 32 of the rope sheave 30, as seen in FIG. 7. Then the sheave segments 30a can be installed to form a full-circle rope sheave 30 (FIG. 8), and the upper support structure 40 is installed and connected to the lower support structure 42 (FIGS. 8 and 9). The upper support structure 40 will minimize the gap between the rope sheave 30 and the adjacent stern roller drum 12, thus functioning a guard to secure that no rope or any other items are jammed or squeezed in-between the rotating parts.

1-11. (canceled)

12. A stern roller arrangement (10) for a vessel (20), comprising:
at least two stern roller drums (12) rotatably supported on a drum axle (14); and
a rope sheave (30) independently and rotatably supported on a sheave axle (32), wherein
the rope sheave (30) is mounted between two of the at least two stern roller drums (12) that are adjacent one another, and
the rope sheave (30) comprises removable sheave segments (30a) that form a circular rope sheave (30) when assembled.

13. The stern roller arrangement (10) according to claim 12, further comprising a plurality of the rope sheaves (30) mounted between the two of the at least two stern roller drums (12) that are adjacent one another.

14. The stern roller arrangement (10) according to claim 13, comprising a support structure (18) supporting the stern roller arrangement (10) to the vessel (20) on either side of the rope plurality of rope sheaves (30).

15. The stern roller arrangement (10) according to claim 14, wherein the support structure (18) comprises a lower support structure (42) with a bearing bed (44) for receipt of the drum axle (14) or the sheave axle (32) for securing the drum axle (14) and the sheave axle (32).

16. The stern roller arrangement (10) according to claim 14, wherein the support structure (18) comprises an upper support structure (40) arranged to at least partly cover a gap between the rope sheave (30) and the adjacent stern roller drum (12).

17. The stern roller arrangement (10) according to claim 12, wherein the drum axle (14) and the sheave axle (32) share a common central axis (22).

18. The stern roller arrangement (10) according to claim 12, wherein the drum axle (14) and the sheave axle (32) have different respective central axes.

19. The stern roller arrangement (10) according to claim 12, wherein the drum axle (14) is supported on the sheave axle (32).

20. The stern roller arrangement (10) according to claim 12, wherein the sheave axle (32) is supported on the drum axle (14).

21. The stern roller arrangement (10) according to claim 12, wherein each end of the drum axle (14) comprises a bearing (16), and the sheave axle (32) comprises a bearing (34).

22. The stern roller arrangement (10) according to claim 12, wherein the sheave segments (30a) are attachable to the sheave axle (32).

23. The stern roller arrangement (10) according to claim 12, comprising a support structure (18) supporting the stern roller arrangement (10) to the vessel (20) on either side of the rope sheave (30).

24. The stern roller arrangement (10) according to claim 23, wherein the support structure (18) comprises a lower support structure (42) with a bearing bed (44) for receipt of the drum axle (14) or the sheave axle (32) for securing the drum axle (14) and the sheave axle (32).

25. The stern roller arrangement (10) according to claim 23, wherein the support structure (18) comprises an upper support structure (40) arranged to at least partly cover a gap between the rope sheave (30) and the adjacent stern roller drum (12).
